(19) United States
(12) Patent Application Publication
(10) Pub. No.: US 2025/0292636 A1
(43) Pub. Date: Sep. 18, 2025

(54) INFORMATION PROCESSING DEVICE

(71) Applicant: TOYOTA JIDOSHA KABUSHIKI KAISHA, Toyota-shi (JP)

(72) Inventors: Hideaki BUNAZAWA, Tokyo (JP); Atsushi TABATA, Okazaki-shi (JP); Koichi OKUDA, Toyota-shi (JP); Yuki MAKINO, Aichi-gun (JP)

(73) Assignee: TOYOTA JIDOSHA KABUSHIKI KAISHA, Toyota-shi (JP)

(21) Appl. No.: 19/070,982

(22) Filed: Mar. 5, 2025

(30) Foreign Application Priority Data
Mar. 15, 2024 (JP) 2024-040812

(51) Int. Cl. G07C 5/08; G06N 20/00; G07C 5/00

(52) U.S. Cl. CPC G07C 5/0816; G06N 20/00; G07C 5/008

(57) ABSTRACT

The processing device of the information processing device includes: a first step of calculating a relative frequency distribution of the original data; a second step of setting a plurality of time windows for clipping data of a partial period of the original data; a third step of clipping data from the original data; a fourth step of calculating a relative frequency distribution in the extracted data; and a fifth step of calculating an error between the relative frequency distribution in the original data and the relative frequency distribution in the extracted data, and performs a search process of repeatedly executing the trial from the second step to the fifth step by changing the setting of the plurality of time windows.

### CROSS-REFERENCE TO RELATED APPLICATION

This application claims priority to Japanese Patent Application No. 2024-040812 filed on Mar. 15, 2024, incorporated herein by reference in its entirety.

### BACKGROUND

### 1. Technical Field

The present disclosure relates to information processing devices.

### 2. Description of Related Art

Japanese Unexamined Patent Application Publication No. 2008-108247 (JP 2008-108247 A) discloses an information processing device that reduces the size of data for analysis by compressing original data for analysis. The original data for analysis is data collected over a predetermined period using sensors mounted on a vehicle.

The information processing device disclosed in JP 2008-108247 A compresses data by extracting, from the original data, data acquired at the time when a certain vehicle speed is reached and data acquired at the time of an inflection point of the vehicle speed.

### SUMMARY

The above information processing device extracts data by focusing only on the vehicle speed. Therefore, the above information processing device cannot extract data according to characteristics of data other than the vehicle speed. There is a demand for an information processing device that can obtain extracted data capturing characteristics of the entire original data including features other than the vehicle speed.

An information processing device that solves the above issue acquires original data collected and created over a predetermined period using a sensor mounted on a vehicle and extracts, from the original data, data to be used to calculate an index value indicating a magnitude of damage accumulated in a torque limiter. The information processing device includes a processing device configured to perform a process. The original data includes data on an amount of slippage of the torque limiter as a feature. In the information processing device, a search process that is performed by the processing device includes a first step of calculating, for each of the features included in the original data, a relative frequency distribution of the original data. The search process includes a second step of setting a plurality of time windows for clipping data of a partial period of the original data in such a manner that a sum of periods of all the time windows is shorter than the predetermined period. The search process includes a third step of clipping data from the original data according to the time windows. The search process includes a fourth step of calculating, for each of the features, the relative frequency distribution of extracted data obtained by combining the data clipped according to the time windows. The search process includes a fifth step of calculating an error between the relative frequency distribution of the original data and the relative frequency distribution of the extracted data. In the search process, after the first step is performed, a trial from the second step to the fifth step is repeatedly performed by changing settings of the time windows. The processing device performs the search process to extract the extracted data with the error equal to or less than a threshold.

In one aspect of the information processing device, the processing device may be configured to perform clustering. The clustering may be machine learning that groups data of each interval obtained by dividing the original data into intervals of a certain period into a predetermined number of clusters. The processing device may be configured to set the time windows in the second step in such a manner that a difference between a proportion of each of the clusters in the extracted data and a proportion of each of the clusters in entirety of the original data is equal to or less than a threshold.

This information processing device can extract extracted data whose amount of data is less than that of the original data and from which an analysis result with the same accuracy as that of the original data is obtained. Therefore, this information processing device can reduce the amount of data of the extracted data compared to that of the original data and can also maintain the same accuracy for the extracted data as that of the original data.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a relationship between a data center, a vehicle, and an information processing terminal, which is an embodiment of an information processing device;

FIG. 2A is a graph showing the original data. It shows a change in amount of slippage of the torque limiter;

FIG. 2B is a graph showing the original data, showing an enlarged view of a portion of FIG. 2A;

FIG. 3 is a flowchart illustrating a flow of processing that is performed by the processing device of the data center;

FIG. 4 is a graph showing an example in which original data is clustered using two features;

FIG. 5A shows an example of the relative frequency distribution in the original data. It shows an example of the relative frequency distribution for the amount of slippage of the torque limiter;

FIG. 5B is a diagrammatic representation of an example of the relative frequency distribution in the original data, showing an example of the relative frequency distribution for the duration of slippage of the torque limiter;

FIG. 6A is a diagram illustrating an example of a relative frequency distribution in original data, showing an example of a relative frequency distribution for an interval of slippage of a torque limiter; and

FIG. 6B is a graph showing an example of the relative frequency distribution in the original data, and shows an example of the relative frequency distribution of the value obtained by multiplying the amount of slippage of the torque limiter and the duration of the slippage.

### DETAILED DESCRIPTION OF EMBODIMENTS

### Configuration of Information Processing System

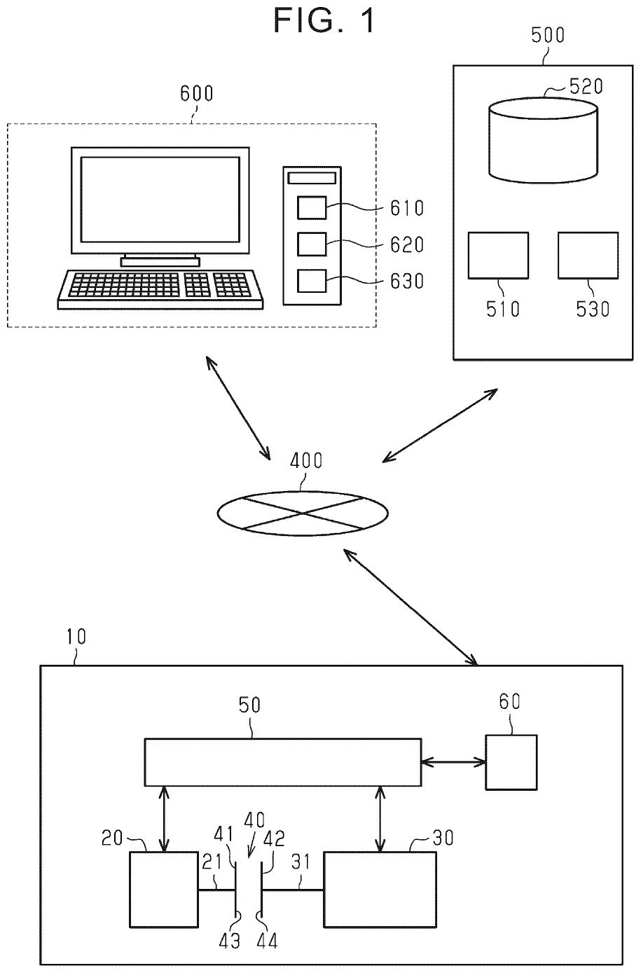

Hereinafter, the data center 500, which is an embodiment of the information processing device, will be described with reference to FIGS. 1 to 6B.

FIG. 1 shows a configuration of an information processing system including a data center 500. As shown in FIG. 1, the data center 500 communicates with the vehicle 10 via a communication network 400. The data center 500 also communicates with the information processing terminal 600 via the communication network 400. The data center 500 communicates with the plurality of vehicles 10 and the plurality of information processing terminals 600 via the communication network 400.

### Configuration of the Data Center 500

As illustrated in FIG. 1, the data center 500 includes a processing device 510. The data center 500 includes a storage device 520 and a communication device 530. The processing device 510 includes a CPU that performs a process according to a program, and a ROM in which the program is stored. The storage device 520 stores a large amount of data. The communication device 530 is implemented as hardware such as a network adapter, various communication software, or a combination thereof. The communication device 530 realizes wired or wireless communication via the communication network 400.

### Configuration of the Vehicle 10

The data center 500 may be configured using a plurality of computers. For example, the data center 500 may be configured by a plurality of server devices.

Each of the plurality of vehicles 10 includes a communication device 60. The communication devices 60 are implemented as hardware such as a network adapter, various communication software, or a combination thereof. The communication devices 60 are configured to realize wired or wireless communication via the communication network 400.

Each vehicle 10 is equipped with an engine 20 and an automatic transmission 30. For example, the automatic transmission 30 is a planetary gear type transmission.

Each vehicle 10 includes a torque limiter 40 provided on a transmission path of power between the engine 20 and the automatic transmission 30. The torque limiter 40 includes an input rotation member 41 and an output rotation member 42. The input rotation member 41 is coupled to an engine coupling shaft 21 that rotates integrally with an output shaft of the engine 20 on a power transmission path. The output rotation member 42 is connected to a transmission coupling shaft 31 that rotates integrally with an input shaft of the automatic transmission 30 on a power transmission path. The input surface 43 of the input rotation member 41 is pressed directly or indirectly against the output surface 44 of the output rotation member 42. Friction between the input surface 43 and the output surface 44 causes the input rotation member 41 and the output rotation member 42 to rotate integrally.

The input surface 43 is not fixed to the output surface 44. Therefore, when an excessive torque exceeding a preset torque acts between the engine 20 and the automatic transmission 30, the output surface 44 rotates relative to the input surface 43. In this way, a phase difference is generated between the input rotation member 41 and the output rotation member 42. The phase difference between the input rotation member 41 and the output rotation member 42 is the slippage of the torque limiter 40. The slippage of the torque limiter 40 suppresses the transmission of excessive torque between the input rotation member 41 and the output rotation member 42.

The vehicle 10 includes a control device 50. The control device 50 controls the engine 20 and the automatic transmission 30.

The control device 50 is equipped with various sensors that collect information of each unit of the vehicle 10.

In each vehicle 10, travel data is collected from the various sensors. The traveling data is transmitted from each vehicle 10 to the data center 500 by the communication device 60. For example, travel data including the travel distance, the position information, and the vehicle speed of each vehicle 10 is transmitted from each vehicle 10 to the data center 500. The travel data also includes various data indicating the state of the torque limiter 40 acquired by the control device 50 of the vehicle 10. Identification information for identifying the respective vehicles 10 is also transmitted from the respective vehicles 10 to the data center 500 together with the traveling data.

The data center 500 stores the traveling data together with the received identification information in the storage device 520. In this way, traveling data of the plurality of vehicles 10 is accumulated in the storage device 520 of the data center 500.

### Configuration of the Information Processing Terminal 600

The information processing terminal 600 includes a processing device 610, a storage device 620, and a communication device 630. The processing device 610 includes a CPU that performs a process according to a program, and a ROM in which the program is stored. The storage device 620 stores data. The communication device 630 is implemented as hardware such as a network adapter, various communication software, or a combination thereof. The communication device 630 realizes wired or wireless communication via the communication network 400. The information processing terminal 600 is, for example, a personal computer.

### Analysis of Travel Data of the Vehicle 10

The information processing terminal 600 is used to analyze travel data. When analyzing the traveling data, an instruction for executing the analysis is transmitted from the information processing terminal 600 to the data center 500. The processing device 510 of the data center 500 that has received the instruction performs analysis using a part of travel data among the enormous travel data stored in the storage device 520 of the data center 500. The travel data to be used is selected from the enormous amount of travel data stored in the storage device 520 in accordance with the purpose of analysis.

For example, the processing device 510 calculates a load applied to a specific component of the specific vehicle 10 based on travel data of the specific vehicle 10. The processing device 510 estimates the damage accumulated in the component based on the calculated load. For example, the processing device 510 calculates an index value indicating the magnitude of the damage accumulated in the torque limiter 40 of the specific vehicle 10 based on the traveling data of the specific vehicle 10. The processing device 510 of the data center 500 outputs the calculated result by transmitting the calculated result to the information processing terminal 600. The information processing terminal 600 that has received the result displays the received result.

In order to perform such an analysis, the processing device 510 analyzes a large amount of travel data collected over a long period of time. Since the processing device 510 needs to perform an enormous amount of computation, it takes a long time to analyze.

Therefore, it is conceivable to extract the extracted data that captures the features of the entire original data from a large amount of travel data that is the original data. If such extracted data can be extracted, the processing device 510 can perform analysis in a shorter time by using the extracted data. For example, in the case of estimating the damage of the torque limiter 40 when the vehicle travels for 100,000 hours, the processing device 510 estimates the damage using the extracted data for 20,000 hours extracted from the original data for 100,000 hours. Then, the processing device 510 multiplies the index value calculated from the extracted data for 20,000 hours by 5 to calculate the index value of the damage of the torque limiter 40 when the vehicle travels for 100,000 hours.

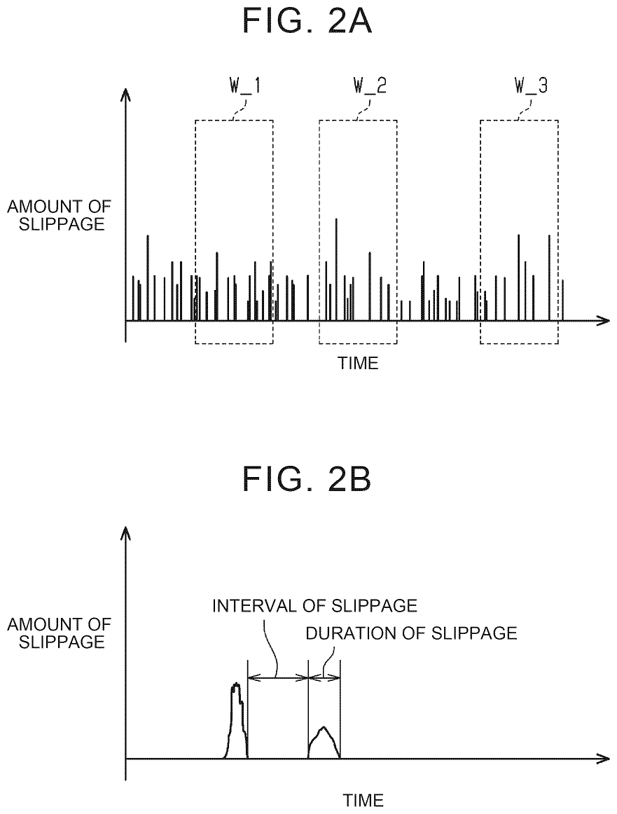

FIGS. 2A and B illustrate exemplary original data. The original data shown in FIG. 2A is travel data for 100,000 hours in one vehicle 10. The original data shown in FIG. 2A includes data of the amount of slippage of the torque limiter 40 to be subjected to calculation of the index value of damage as the feature.

FIG. 2A shows a change in amount of slippage for 100,000 hours. The amount of slippage is a rotational speed difference between the input rotation member 41 and the output rotation member 42. The control device 50 acquires the amount of slippage from the rotational speed of the output shaft of the engine 20 and the rotational speed of the input shaft of the automatic transmission 30. Data on the rotational speed of the output shaft of the engine 20 and the rotational speed of the output shaft of the automatic transmission 30 may be transmitted from the vehicle 10 to the data center 500 to calculate the amount of slippage in the data center 500.

The amount of slippage correlates with the damage of the torque limiter 40 of the vehicle 10. The processing device 510 of the data center 500 estimates the damage of the torque limiter 40 from the travel data including the amount of slippage as the feature.

FIG. 2B shows an enlarged view of a part of the horizontal axis of FIG. 2A. In a portion where the amount of slippage is 0, the input rotation member 41 and the output rotation member 42 of the torque limiter 40 rotate integrally, and slippage does not occur. When slippage starts at the torque limiter 40, the amount of slippage becomes greater than zero, and when the slippage ends at the torque limiter 40, the amount of slippage becomes zero again. In this specification, the time from the start of slippage of the torque limiter 40 until the end of the slippage is referred to as the duration of the slip. Further, a period from the end of the slippage of the torque limiter 40 until the start of the next slippage is referred to as an interval of slippage.

The original data may include, as the feature, at least one of the following values: a duration of slippage of the torque limiter 40, an interval of slippage of the torque limiter 40, and the value obtained by multiplying the amount of slippage and the duration of the slippage. The duration of slippage and the interval of slippage can be calculated based on the time variation of the amount of slippage. The duration of slippage and the interval of slippage are calculated by the control device 50 on the basis of the change in amount of slippage with time. In the data center 500, the duration of slippage and the interval of slippage may be calculated based on the change in the amount of slippage with time.

The value obtained by multiplying the amount of slippage and the duration of slippage is calculated for each slippage. The control device 50 calculates the value obtained by multiplying the amount of slippage and the duration of slippage, based on the amount of slippage and the duration of the slippage. The value obtained by multiplying the amount of slippage and the duration of slippage may be calculated in the data center 500. In the calculation of the value obtained by multiplying the amount of slippage and the duration of the slip, the amount of slippage multiplied by the duration of slippage may be the maximum value of the amount of slippage in the duration of slippage or the average value of the amount of slippage in the duration of slippage.

The duration of the slip, the interval of the slip, and the value obtained by multiplying the amount of slippage and the duration of slippage correlate with the damage of the torque limiter 40 of the vehicle 10. In addition to the amount of slippage, the processing device 510 of the data center 500 may estimate the damage of the torque limiter 40 from the travel data including at least one of the following values as the feature: the duration of slippage, the interval of slippage, the value obtained by multiplying the amount of slippage and the duration of slippage.

The extracted data is created by clipping the data from the original data by a plurality of time windows. In FIG. 2A, three time windows of the first time window W_1, the second time window W_2, and the third time window W_3 are indicated by broken lines, respectively, as part of the plurality of time windows. The beginning and end of each time window are set such that the respective time windows do not overlap. In this example, the traveling data for 20,000 hours is extracted as the extracted data. Therefore, the start and end periods of each time window are set so that the total length of the time periods of all the time windows is 20,000 hours.

The data center 500 searches for the setting of the start time and the end time of each time window indicating the clipping pattern for extracting the extracted data that captures the features of the entire original data.

The data center 500 extracts the extracted data from the original data by using the clipping pattern found by the search. The data center 500 performs analysis using the extracted data.

### Search Process for Clipping Patterns

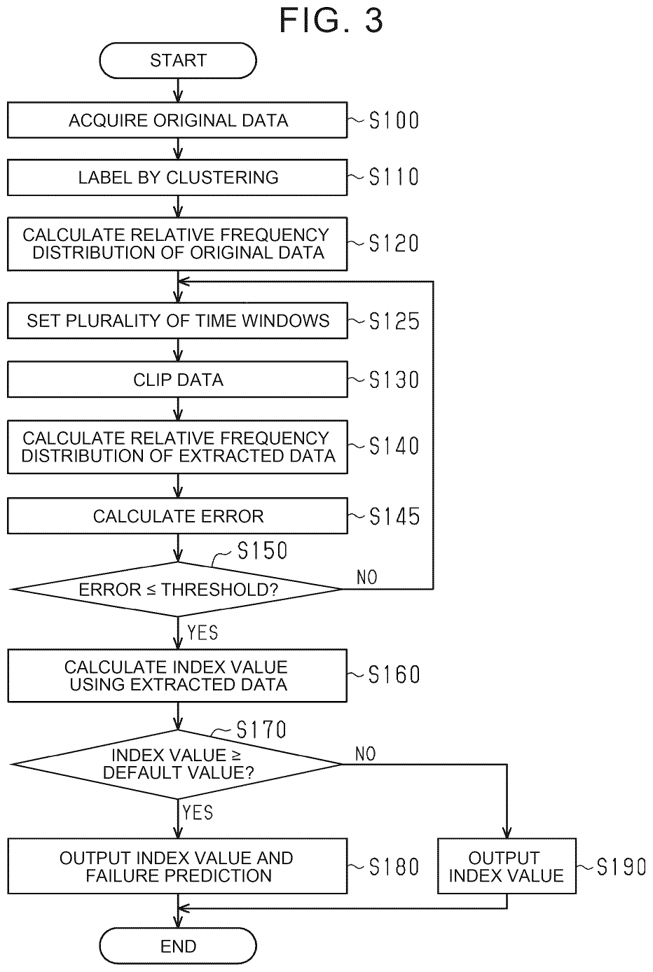

FIG. 3 is a flowchart illustrating a flow of a series of processes related to the extraction pattern search process. This series of processing is performed by the processing device 510 of the data center 500.

As illustrated in FIG. 3, the processing device 510 acquires the original data in the processing of S100. The original data is a part of the travel data selected for the purpose of analysis from the enormous travel data stored in the storage device 520 of the data center 500. For example, the original data for calculating the index value indicating the magnitude of the damage accumulated in the torque limiter 40 of one vehicle 10 is travel data over a predetermined period of the target vehicle 10 selected from the huge travel data of the plurality of vehicles 10. For example, in the case of estimating the damage of the torque limiter 40 when traveling for 100,000 hours, the original data is traveling data over a predetermined period of the target vehicle 10.

In S110 process, the processing device 510 labels the original data by clustering. Specifically, the processing device 510 divides the original data at regular intervals. The length of the period for separating the original data is, for example, several minutes. Then, the processing device 510 performs clustering which is machine learning for classifying the data of each interval into a predetermined number of clusters. For example, k-means method is used as the algorithm of clustering. k-means method is a clustering algorithm for classifying data into a predetermined number of clusters. The clustering algorithm is not limited to k-means method.

The original data includes travel data collected under different environments, such as travel data when traveling in an urban area, travel data when traveling in a suburban area, and travel data when traveling on an expressway. By performing clustering, the travel data included in the original data can be classified into clusters of travel data having similar characteristics. The number of clusters to be classified is arbitrarily set according to the contents of the analysis.

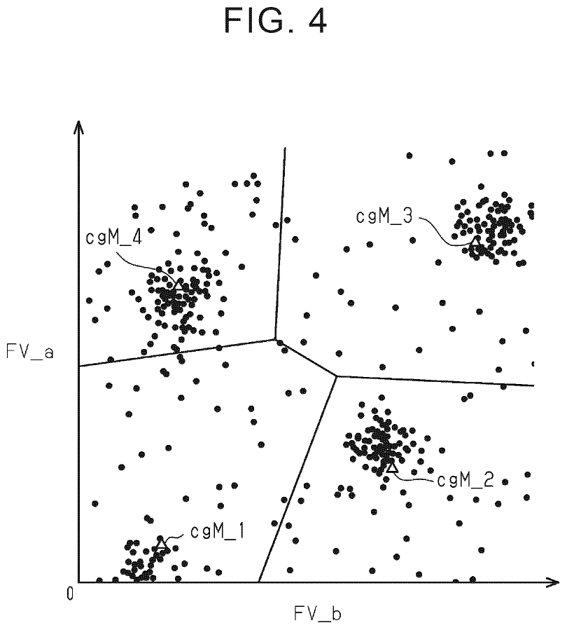

FIG. 4 is a graph illustrating an exemplary clustering of original data into four clusters by a k-means method using two features included in the original data as explanatory variables. For example, the two features are the amount of slippage and the duration of the slip. In FIG. 4, each piece of data in each interval partitioned from the original data is indicated by a single point. When performing clustering, the processing device 510 uses a representative value of an explanatory variable in the data of each interval. For example, the processing device 510 sets the average value of the features in the data of each interval as a representative value. The processing device 510 may use, as the representative value, the moving average value of the feature in a plurality of consecutive intervals in time series.

In FIG. 4, these points are shown in a two-dimensional space with the first feature FV_a and the second feature FV_b as coordinate axes. FIG. 4 is an example in which original data is clustered in four clusters of the first cluster M_1, the second cluster M_2, the third cluster M_3, and the fourth cluster M_4. In FIG. 4, the boundaries of the four clusters are indicated by solid lines. In FIG. 4, the center of gravity of each cluster is indicated by an open triangle. The center of gravity cgM_1 is the center of gravity of the first cluster M_1. The center of gravity cgM_2 is the center of gravity of the second cluster M_2. The center of gravity cgM_3 is the center of gravity of the third cluster M_3. The center of gravity cgM_4 is the center of gravity of the fourth cluster M_4.

Although FIG. 4 shows an example in which the number of explanatory variables is two, the number of explanatory variables is not limited to two. For example, when the original data includes three features, the processing device 510 may perform clustering using these three features as explanatory variables. In this case, the processing device 510 clusters the original data in the three-dimensional space.

The processing device 510 assigns a label indicating the result of the clustering in this way to the original data. Specifically, each data indicated by a point in the coordinate space is given a label for identifying a cluster in which the data is classified. In this way, the processing device 510 creates the original data to which the label is attached.

Next, the processing device 510 calculates the relative frequency distribution of the original data in the processing of S120. When a plurality of features is included in the original data, the processing device 510 calculates a relative frequency distribution in the original data for each feature.

The frequency distribution classifies data into a plurality of classes, and represents a frequency distribution that is the number of data of each class. The relative frequency indicates how much the frequency of the class accounts for the sum of the total frequencies.

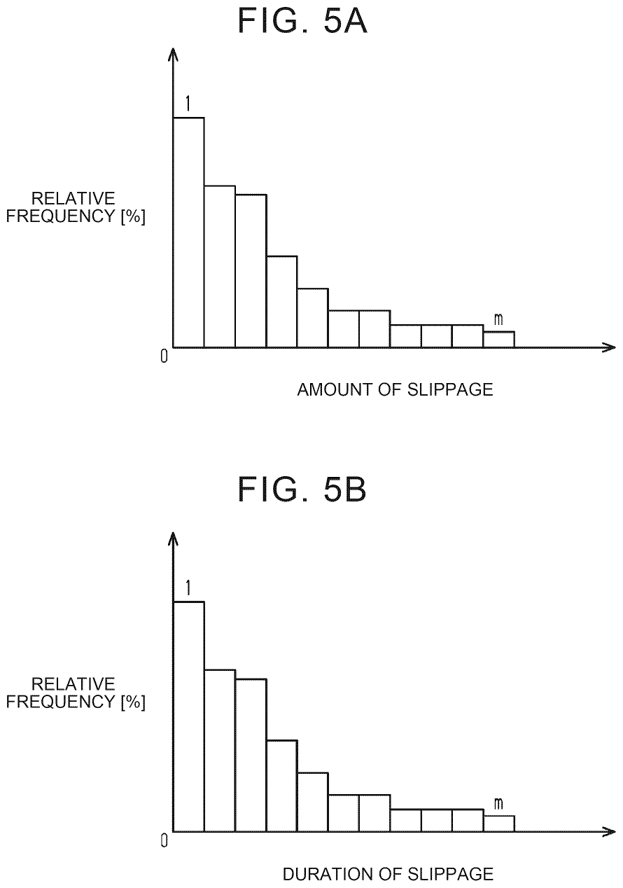

FIG. 5A shows the relative frequency distribution for the amount of slippage in the original data shown in FIGS. 2A and 2B. In this relative frequency distribution, the class of the amount of slippage in the original data is divided into m classes from 1 to m, and the relative frequency distribution is shown.

FIG. 5B shows the relative frequency distribution for the duration of slippage in the original data shown in FIGS. 2A and 2B. In this relative frequency distribution, the class of the duration of slippage in the original data is divided into m classes from 1 to m, and the relative frequency distribution is shown.

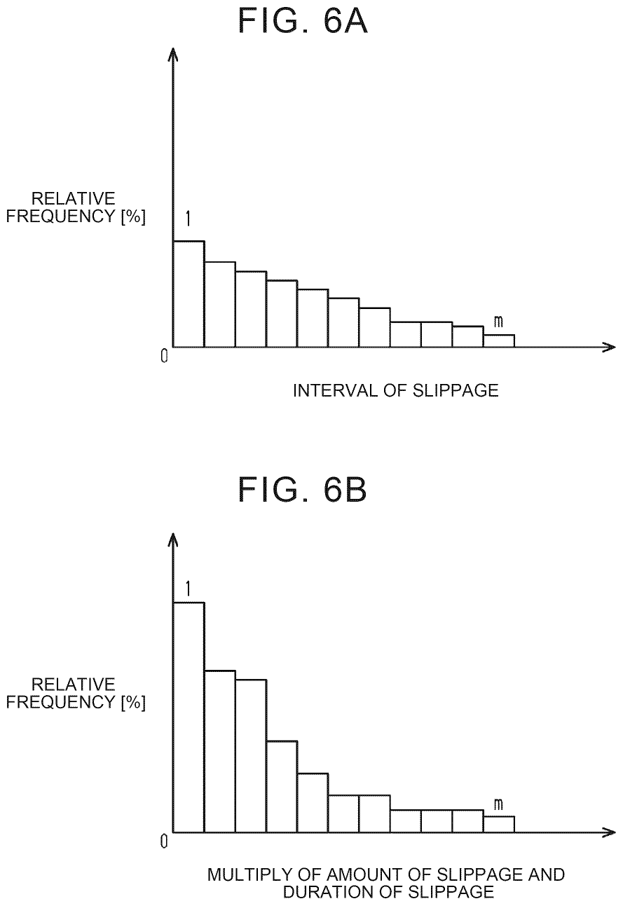

FIG. 6A shows the relative frequency distribution for the interval of slippage in the original data shown in FIGS. 2A and 2B. In this relative frequency distribution, the class of the interval of slippage in the original data is divided into m classes from 1 to m, and the relative frequency distribution is shown.

FIG. 6B shows the relative frequency distribution for the value obtained by multiplying the amount of slippage and the duration of the slippage in the original data shown in FIGS. 2A and 2B. In this relative frequency distribution, the class of the value obtained by multiplying the amount of slippage and the duration of slippage in the original data is divided into m classes from 1 to m, and the relative frequency distribution is shown.

In S120 process, the processing device 510 calculates the relative frequency distribution for each feature included in the original data. The number of classes in the relative frequency distribution of each feature is the same.

Next, in S125 process, the processing device 510 sets a plurality of time windows in order to extract the extracted data from the original data.

In FIG. 2A, three time windows W_1 to W_3 of the first time window W_1, the second time window W_2, and the third time window W_3 are illustrated as examples of a plurality of time windows. In the case shown in FIG. 2A, the time windows are all equal.

In S125 process, the processing device 510 randomly sets a plurality of time windows such that the total time period of all time windows is shorter than a predetermined period, which is the total time period of the original data. As will be described later, the processing device 510 combines all the data clipped according to the plurality of time windows set here to generate extracted data. The total time period of all the time windows is a value for determining the capacity of the extracted data. Therefore, a period in which all the time windows are summed is set in advance.

For example, the processing device 510 randomly sets the number of time windows, the start of each time window, and the end of each time window each time S125 process is performed. At this time, the processing device 510 sets each time window so that each time window does not overlap. The processing device 510 thus randomly sets the plurality of time windows such that the total period of all time windows is a preset period. In S125 process, the processing device 510 may set a plurality of time windows by fixing the time periods of the respective time windows to be constant, as shown in FIG. 2A and FIG. 2B. In S125 process, the processing device 510 may fix the plurality of time windows to a fixed number and set the plurality of time windows.

In addition to the above requirements, when setting a plurality of time windows through S125, the processing device 510 sets a plurality of time windows such that a difference between a proportion of each cluster in the extracted data and a proportion of each cluster in the entire original data is equal to or less than a threshold.

In this way, by setting a plurality of time windows through S125 process, a clipping pattern in which data is cut out from the original data is determined. When the processing device 510 determines the clipping pattern in this way, the processing proceeds to S130.

In S130 process, the processing device 510 clips data from the original data in the determined clipping pattern. That is, in S130 process, the processing device 510 clips data from the original data by a plurality of set time windows. Then, the processing device 510 combines all the data clipped according to the plurality of time windows to create extracted data.

In the process of the following S140, the processing device 510 calculates the relative frequency distribution of the extracted data. The processing device 510 calculates the relative frequency distribution of the extracted data in the same manner as the method of calculating the relative frequency distribution in S120. In other words, in S140 process, the processing device 510 calculates the relative frequency distribution of the extracted data for each feature. At this time, the processing device 510 sets the number of classes in the relative frequency distribution of each feature to be the same as the relative frequency distribution in S120.

Next, in S145 process, the processing device 510 calculates an error between the relative frequency distribution in the original data and the relative frequency distribution in the extracted data. For example, the processing device 510 calculates a mean absolute error (MAE). The mean absolute error MAE is expressed by the following equation.

### Mathematical Formula 1

$$MAE = \frac{1}{n} {\sum }_{i = 1}^{n} {\sum }_{j = 1}^{m} \vert {Y}_{n m} - {y}_{n m} \vert$$

In the above equation, “n” is the number of features. “m” is the number of series in the relative frequency distribution. “Y” is the frequency of the corresponding feature in the original data in the corresponding class. “y” is the frequency of the corresponding feature in the extracted data in the corresponding class.

As shown in the above equation, the processing device 510 calculates, as an error, the sum of the errors of the frequencies in the respective classes for each feature between the relative frequency distribution in the entire original data and the relative frequency distribution in the extracted data.

After calculating the error, the processing device 510 advances the processing to S150. In S150 process, the processing device 510 determines whether or not the calculated error is less than or equal to the thresholds. The threshold is a value for determining whether or not the extracted data having the relative frequency distribution close to the relative frequency distribution in the original data is extracted by the set clipping pattern. The magnitude of the threshold is set in advance so that it can be determined that extracted data having a relative frequency distribution close to the relative frequency distribution in the original data is extracted based on the error being equal to or smaller than the threshold.

In S150 process, when it is determined that the error is equal to or smaller than the threshold (S150: YES), the processing device 510 advances the process to S160. In S160 process, the processing device 510 calculates the intended index value using the extracted data generated in the process of the latest S130. Here, an index value indicating the magnitude of the damage accumulated in the torque limiter 40 is calculated. For example, the processing device 510 calculates the degree of breakage as an index value indicating the magnitude of damage accumulated in the torque limiter 40.

The degree of breakage is an index value representing the ratio of accumulated damage, assuming that the damage of the torque limiter 40 gradually accumulates, with the damage leading to breakage being “1”. Here, the damage applied to the torque limiter 40 during a certain period is calculated based on the amount of slippage data. The damage to the torque limiter 40 may be calculated from the amount of slippage and at least one of the following values as a feature: the duration of the slippage, the interval of the slippage, and the value obtained by multiplying the amount of slippage and the duration of slippage. Then, the ratio of damage calculated with the magnitude of damage leading to breakage of the torque limiter 40 being “1” is calculated as an index value. By repeating this process, the degree of breakage, that is, the ratio of accumulated damage to damage leading to breakage, is calculated. When the degree of breakage becomes “1”, it means that the damage leads to breakage. The calculated degree of breakage is a value in the range of “0” to “1”.

Here, since the degree of breakage is calculated using the extracted data that is part of the original data, the processing device 510 converts the calculated degree of breakage to a magnitude corresponding to the original data, and calculates the degree of breakage as the index value. For example, when the original data is travel data for 100,000 hours and the extracted data is travel data for 20,000 hours, the calculated degree of breakage is multiplied by five to obtain the degree of breakage as the index value.

On the other hand, in S150 process, when it is determined that the error is larger than the threshold (S150: NO), the processing device 510 returns the process to S125. Then, the processing device 510 performs the search process from S125 to S145 again.

In this way, the processing device 510 repeatedly performs the search process from S125 to S145 by changing the settings of the plurality of time windows, and extracts extracted data in which the error becomes equal to or less than the threshold from the original data. Then, the processing device 510 calculates an index value using the extracted data. After calculating the index value, the processing device 510 advances the processing to S170.

In S170 process, the processing device 510 determines whether or not the index value is equal to or greater than a predetermined value. The default value is a value for predicting that breakage is more likely to occur based on the fact that the index value is equal to or larger than the default value. For example, “0.9” can be set here, for example, as a default value in the degree of breakage. In this case, it is possible to predict that the possibility of the damage is high based on the fact that the damage has reached 90% of damage leading to the damage.

In S170 process, when it is determined that the index value is equal to or greater than the predetermined value (S170: YES), the processing device 510 advances the process to S180. In S180 process, the processing device 510 outputs an index value and a failure prediction. Specifically, the processing device 510 transmits the index value and the failure prediction to the information processing terminal 600 that has transmitted the instruction for requesting the analysis.

The failure prediction is, for example, a message indicating that the occurrence of a failure has been predicted. In this way, when the calculated index value is equal to or greater than the predetermined value, the processing device 510 notifies that the occurrence of the failure has been predicted. The failure prediction may be information of a lifetime until a failure occurs. For example, when the degree of breakage calculated by using the extracted data extracted from the original data for 100,000 hours is the index value, the processing device 510 calculates the traveling time until the degree of breakage reaches “1” and outputs the calculated traveling time as the information of the life. The information on the life may be converted into the traveling distance based on the traveling distance of 100,000 hours and output.

In S170 process, when it is determined that the index value is less than the predetermined value (S170: NO), the processing device 510 advances the process to S190. In S190 process, the processing device 510 outputs an index value. Specifically, the processing device 510 transmits the index value to the information processing terminal 600 that has transmitted the instruction for requesting the analysis.

### Operation of this Embodiment

When S180 or S190 process is performed, the processing device 510 ends the series of processes. The data center 500, which is the information processing device of the present embodiment, acquires original data collected and created over a predetermined period using a sensor mounted on the vehicle 10, and calculates an index value indicating the magnitude of damage accumulated in the torque limiter 40.

The data center 500 includes a processing device 510 that performs a process. The original data includes data of the amount of slippage of the torque limiter 40 as the feature. In addition to the amount of slippage, the original data further includes at least one of the following data as a feature: the duration of slippage, the interval of slippage, and the value obtained by multiplying the amount of slippage and the duration of slippage. In the data center 500, the search process that is performed by the processing device 510 includes a first step of calculating, for each of the features included in the original data, a relative frequency distribution of the original data (S120). The search process includes a second step of setting a plurality of time windows for clipping data of a partial period of the original data in such a manner that a sum of periods of all the time windows is shorter than the predetermined period (S125). The search process includes a third step of clipping data from the original data according to the time windows (S130). The search process includes a fourth step of calculating, for each of the features, the relative frequency distribution of extracted data obtained by combining all the data clipped according to the time windows (S140). The search process includes a fifth step of calculating an error between the relative frequency distribution of the original data and the relative frequency distribution of the extracted data (S145). In the search process, after performing the first step, the processing device 510 repeatedly performs a trial from the second step to the fifth step by changing settings of the time windows. Then, the processing device 510 extracts the extracted data in which the error is equal to or less than the threshold (S150: YES). The processing device 510 calculates an index value using the extracted data in which the error becomes equal to or smaller than the threshold (S160).

According to the data center 500, it is possible to obtain extracted data capturing characteristics of the entire original data including a plurality of features are captured. The extracted data has a smaller amount of data than the original data and has the same accuracy as the original data. Therefore, the data center 500 can calculate the index value with the same accuracy as in the case of using the original data by using the extracted data.

### Effect of this Embodiment

According to the data center 500 that is the information processing device of the present embodiment, it is possible to extract extracted data that has a smaller data amount than the original data and that can obtain an analysis result equivalent to the original data.

According to the data center 500 that is the information processing device of the present embodiment, it is possible to achieve both reduction in the amount of data and calculation accuracy of the index value.

According to the data center 500 which is the information processing device of the present embodiment, it is possible to calculate the index value in a shorter time than in the case where the original data is used.

The processing device 510 performs clustering, which is machine learning for classifying the data of the intervals obtained by dividing the original data into a predetermined number of clusters at regular intervals (S110). Then, in the second step (S125) of the search process, the processing device 510 sets a plurality of time windows such that the difference between the proportion of each cluster in the extracted data and the proportion of each cluster in the entire original data is equal to or less than the threshold.

A plurality of intervals classified into the same cluster is intervals having similar characteristics. In the above search process, the setting output from the processing device 510 is a setting in which the difference in proportion of each cluster from the entire original data is equal to or less than the threshold, and the extracted data having the relative frequency distribution of each feature close to each other can be extracted.

Therefore, according to the search process performed by the data center 500, it is possible to find a setting that can obtain extracted data closer to the characteristics of the entire original data.

The processing device 510 terminates the search process when one piece of extracted data whose error becomes equal to or smaller than the threshold can be extracted, and calculates an index value using the extracted data whose error becomes equal to or smaller than the threshold. Therefore, the data center 500 can calculate an index value at a time point when one piece of extracted data whose error becomes equal to or smaller than the threshold can be extracted, and output the result promptly.

When the calculated index value is equal to or greater than the predetermined value (S170: YES), the processing device 510 notifies that a failure has been predicted. Therefore, the data center 500 can notify the user that the occurrence of the failure has been predicted before the failure occurs.

The processing device 510 calculates a degree of breakage as an index value. Therefore, the data center 500 can inform the user of how long the delay until the failure is reached.

### Example of Change

The present embodiment can be modified to be implemented as follows. The present embodiment and modifications described below may be carried out in combination within a technically consistent range.

In the above information processing method, in a fifth step, the processing device 510 calculates a interval error that is a difference in the relative frequency of each class between the relative frequency distribution of the original data and the relative frequency distribution of the extracted data, and simply calculates the sum thereof. On the other hand, the sum of the interval errors may be calculated as an error after multiplying the calculated interval errors by a weight and adding the adjustment.

In S140 process, the processing device 510 calculates the relative frequency distribution of the extracted data, and then calculates an interval error that is a difference between the relative frequencies of the respective classes in the relative frequency distribution of the original data and the relative frequency distribution of the extracted data. Next, the processing device 510 multiplies the calculated interval error by the weight for each class, and adjusts the interval error for each class. Then, in S145, the processing device 510 calculates the sum of the adjusted interval errors as an error. The processing device 510 performs the processing after S150 using the error calculated in this way.

An example of a variable for determining the weight is an air temperature when slippage of the torque limiter 40 occurs. The processing device 510 adjusts the error based on the temperature when slippage occurs in the torque limiter 40. In S140, the processing device 510 heavily evaluates the slippage that occurred when the air temperature was high. Specifically, the processing device 510 is configured to calculate the relative frequency distribution of the extracted data in S140 by adjusting the amount of slippage in slippage when the air temperature when slippage occurs is high. Alternatively, the processing device 510 may be configured to calculate the relative frequency distribution of the extracted data in S140, and adjust the amount of slippage in slippage to be small when the temperature when the slippage occurs is low. Then, in S145 process, the processing device 510 calculates an error between the relative frequency distribution in the original data and the relative frequency distribution adjusted based on the air temperature in the extracted data.

The damage to the torque limiter 40 when the temperature is high tends to be greater than the damage to the torque limiter 40 when the temperature is low. By adjusting the error based on the air temperature when slippage occurs in the torque limiter 40 as described above, it is possible to further improve the calculation accuracy of the index value.

In the above embodiment, an example in which the information processing device is embodied as the data center 500 has been described. An example in which the index value is calculated in the data center 500 has been described. On the other hand, the information processing device described above may be embodied as the information processing terminal 600. In this case, the calculation of the index value is performed by the processing device 610 of the information processing terminal 600. The above information processing device may be embodied as the control device 50 of the vehicle 10. In this case, the calculation of the index value can also be performed by the control device 50 of the vehicle 10.

An example has been described in which the data center 500, which is an information processing device, performs extraction of extracted data from original data and calculation of an index value. In contrast, the information processing device may be a device that performs up to extraction of extracted data from original data. For example, the data center 500 may extract the extracted data from the original data and transmit the extracted data to the information processing terminal 600. In this case, the information processing terminal 600 that has received the extracted data calculates the index value. For example, the control device 50 of the vehicle 10 may extract the extracted data from the original data and transmit the extracted data to the data center 500. In this case, the data center 500 that has received the extracted data calculates the index value.

In the above embodiment, an example has been described in which one piece of extracted data is extracted and an index value is calculated. On the other hand, a final index value may be determined by extracting a plurality of pieces of extracted data and using a plurality of index values calculated using the respective pieces of extracted data. For example, the minimum value, the maximum value, the mode value, and the average value are set as final index values. Further, a plurality of index values may be output.

In the above embodiment, an example has been described in which, when the index value is equal to or larger than a predetermined value, it is notified that the occurrence of a failure has been predicted. This may be omitted. After the index value is calculated, only S190 process may be performed, and only the index value may be output.

Although the degree of breakage is exemplified as an example of the index value to be calculated, the index value to be calculated is not limited to the degree of breakage.

The processing device 510 sets a plurality of time windows such that a difference between a proportion of each cluster in the original data and a proportion of each cluster in the extracted data is equal to or smaller than a threshold. Without such a restriction, the processing device 510 may set a plurality of time windows. In such cases, the process S110 clustering may be omitted.

The method of determining the setting of the time window in the clipping pattern may not be random. The trial may be repeated by changing the setting of the time window in the clipping pattern according to a preset rule.

The error calculated in S145 process is not limited to the mean absolute error MAE. For example, the processing device 510 may calculate a mean square error as an error. The processing device 510 may calculate a root mean square error as an error.

An example using extracted data obtained by combining all extracted data is shown. On the other hand, some of the extracted data may be combined to create extracted data.

What is claimed is:

1. An information processing device that acquires original data collected and created over a predetermined period using a sensor mounted on a vehicle and extracts, from the original data, data to be used to calculate an index value indicating a magnitude of damage accumulated in a torque limiter, the information processing device comprising a processing device configured to perform a process, wherein:
the original data includes data on an amount of slippage of the torque limiter as a feature;
the processing device is configured to perform a search process, the search process including
a first step of calculating, for each of the features included in the original data, a relative frequency distribution of the original data,
a second step of setting a plurality of time windows for clipping data of a partial period of the original data in such a manner that a sum of periods of all the time windows is shorter than the predetermined period,
a third step of clipping data from the original data according to the time windows,
a fourth step of calculating, for each of the features, the relative frequency distribution of extracted data obtained by combining the data clipped according to the time windows, and
a fifth step of calculating an error between the relative frequency distribution of the original data and the relative frequency distribution of the extracted data, and
after the first step is performed, a trial from the second step to the fifth step being repeatedly performed by changing settings of the time windows, and the processing device performing the search process to extract the extracted data with the error equal to or less than a threshold.

2. The information processing device according to claim 1, wherein the original data further includes, as the feature, at least one of the following values: a duration of the slippage of the torque limiter, an interval of the slippage of the torque limiter, and a value obtained by multiplying the amount of the slippage and the duration of the slippage.

3. The information processing device according to claim 1, wherein the processing device is configured to adjust the error based on an air temperature when the slippage of the torque limiter occurs.

4. The information processing device according to claim 1, wherein:
the processing device is configured to perform clustering, the clustering being machine learning that groups data of each interval obtained by dividing the original data into intervals of a certain period into a predetermined number of clusters; and
the processing device is configured to set the time windows in the second step in such a manner that a difference between a proportion of each of the clusters in the extracted data and a proportion of each of the clusters in entirety of the original data is equal to or less than a threshold.

5. The information processing device according to claim 1, wherein the processing device is configured to calculate, as the index value, a degree of breakage using the extracted data with the error equal to or less than the threshold, the degree of breakage indicating a ratio of the accumulated damage to damage that leads to breakage.
